(19) United States
(12) Patent Application Publication
(10) Pub. No.: US 2026/0072556 A1
(43) Pub. Date: Mar. 12, 2026

(54) Visual Indicators For AI-Generated Content And Related Systems And Methods

(71) Applicant: Oracle International Corporation, Redwood Shores, CA (US)

(72) Inventors: Jennifer Darmour, Seattle, WA (US); Jenny Toi Wah Lam, Seattle, WA (US); Hillel Noah Cooperman, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/939,308

(22) Filed: Nov. 6, 2024

Related U.S. Application Data
(60) Provisional application No. 63/691,693, filed on Sep. 6, 2024.

(51) Int. Cl. G06F 3/0481; G06F 3/0484; G06F 40/166

(52) U.S. Cl. CPC G06F 3/0481; G06F 3/0484; G06F 40/166

(57) ABSTRACT

Techniques for visual indicators for AI-generated content are disclosed herein. A graphical user interface displays content items that have been generated by AI with visual indicators. In some cases, the AI-generated content is known to be AI-generated or is received with an indication that the content is AI-generated. In other cases, whether a content item was generated using AI is determined by evaluating the content item using a model. Attributes of the visual indicator, such as color, shape, or size, represent a confidence that the content was generated by AI and/or a confidence that the AI-generated content is accurate. AI-generated draft work items are also presented with visual indicators. Example visual indicators include a bar, box, or other form of emphasis around or next to a content item or content item portion.

### INCORPORATION BY REFERENCE; DISCLAIMER

Each of the following applications are hereby incorporated by reference: Application No. 63/691,693 filed on Sep. 6, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to visual indicators used that are used to identify content that has been generated by artificial intelligence (AI).

### BACKGROUND

Artificial intelligence (AI) is used in many applications, such as to create natural language responses to questions, create natural language summaries of input information included with a prompt, and create images based on input text. Often, content that has been generated by AI is presented in a mix with human-generated content elements or empirical data content elements. For this and other reasons, readers may not know which parts of a document are generated by AI and which come from another source. Furthermore, AI models can hallucinate details, furthering the need for the reader to be able to easily understand the parts of a document that were generated by AI.

Techniques in this disclosure may address any of the aforementioned flaws, challenges, and difficulties by providing techniques that result in improved heterogeneous content management. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example visual indicator system in accordance with one or more embodiments;

FIGS. 2A-B illustrate example sets of operations for a visual indicator system in accordance with one or more embodiments;

FIGS. 3A-E illustrate example graphical user interfaces (GUIs) for a dashboard using a visual indicator system in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. INTRODUCTION
3. CONTENT TYPE IDENTIFICATION SYSTEM
4. VISUALLY DISTINGUISHING AI-GENERATED CONTENT FROM NON-AI-GENERATED CONTENT
5. EXAMPLE EMBODIMENTS
6. COMPUTER NETWORKS AND CLOUD NETWORKS
7. MICROSERVICE APPLICATIONS
8. HARDWARE OVERVIEW
9. MISCELLANEOUS; EXTENSIONS

### 1. GENERAL OVERVIEW

One or more embodiments modify a Graphical User Interface (GUI) to visually distinguish AI-generated content from non-AI-generated content. The system adds visual indicators such as, for example, shading, coloring, labels, boxes, or call-outs to either or both AI-generated content and non-AI-generated content. In an example, the system adds a box with colored lines around AI-generated content. The box with colored lines, which may be referred to herein as a “bloom,” visually indicates to a viewer that the content within the box includes AI-generated content. Furthermore, the lack of the box with the colored lines around other content visually indicates to the viewer that the other content is not AI-generated content. In another example, the system modifies the non-AI-generated content without modifying the AI-generated content. The system highlights text that is not AI-generated without modifying text that is AI-generated. In this example, the highlighting of content indicates to a viewer that the highlighted content is not AI-generated while the rest of the content (i.e., non-highlighted content) is AI-generated content. Furthermore, the system may annotate both the AI-generated content and the non-AI-generated content using different visual indicators that enable a viewer to distinguish the AI-generated content from the non-AI-generated content. In an example, the system uses different colors, respectively, for AI-generated content and non-AI-generated content.

One or more embodiments execute a runtime analysis of each set of content that is to be displayed within a GUI to determine whether the set of content is AI-generated or not AI-generated. The runtime analysis may include an analysis of a label associated with a set of content that explicitly identifies the content as being AI-generated or non-AI-generated. The runtime analysis may include a determination based on a source of the set of content. In an example, the system assembles different sets of content from different respective sources. Each source is known to provide AI-generated content or non-AI-generated content. Accordingly, based on the source of any particular set of content, the system determines whether the particular set of content is AI-generated or non-AI-generated. The runtime analysis of a set of content may be based on a location within the GUI where the set of content is being presented. In an example, a region of the GUI is designated for displaying AI-generated content while another region of the GUI is designated for displaying non-AI-generated content. Depending on where the set of content is being displayed within the GUI, the system determines whether the content is AI-generated or non-AI-generated. The runtime analysis may include applying a function or a machine learning model to a set of content for estimating whether the set of content is AI-generated or non-AI-generated. The function or machine learning model determines whether the set of content is AI-generated or non-AI-generated, based on analysis of one or more attributes of the set of content such as structure, repetition, term frequency, etc.

Applicant notes that this Overview is non-limiting in nature, and that additional embodiments and related combinations of features are described in this Specification and/or recited in the claims.

### 2. INTRODUCTION

Automated reports often blend AI-generated content with non-AI-generated content to create comprehensive and insightful documents. In various fields, such as medical, financial, sports data, and others, both AI content pieces and non-AI content pieces are used in automated generation of documents, reports, summaries, or other content.

For example, in the medical field, traditional methods involve healthcare professionals collecting data through patient interactions, lab results, and imaging studies. These professionals analyze the data to diagnose conditions and recommend treatments, manually compiling their findings into structured reports. Conversely, AI methods employ natural language processing systems and other AI models to analyze patient data, including electronic health records, lab results, and medical images. AI systems generate reports that summarize findings, suggest diagnoses, and recommend treatments that healthcare professionals review and validate.

In the financial and tax sectors, generating traditional financial or tax reports involves collecting data from various sources, like bank statements, market data, and/or transaction records. Analysts manually analyze this data to gain insights into financial performance, compiling their findings into structured reports. AI methods enhance this process by using machine learning models to analyze large datasets, identify trends, and make financial performance predictions. These AI systems can automatically generate detailed financial reports, including income statements, balance sheets, and cash flow statements.

In the realm of sports, traditional methods involve human scorers or manual data entry to collect sports statistics during games. Sports analysts then manually analyze these statistics and player performances, creating reports that summarize game results and insights. Artificial Intelligence methods, however, utilize models to analyze real-time game data, including player movements and scores, enabling them to automatically generate detailed sports reports.

A specific example of a system generating reports is the process of producing medical test results. Initially, medical test results, such as blood tests or imaging studies, are collected and stored in an electronic health record (EHR) system. An AI model, using a deep learning algorithm, then analyzes these results. For instance, an AI system analyzes X-ray images to detect signs of pneumonia. Based on its analysis, the AI system generates a preliminary report, summarizes findings, details, and/or test results, and suggests next steps or treatments. A healthcare professional reviews this AI-generated report, validates the findings, and adds additional insights or recommendations. The final report, combining AI-generated content with the healthcare professional's input, is then generated for review by the healthcare professional, edited, and/or, and shared with the patient.

Similarly, in generating bank information reports, a bank collects transaction data from customer accounts, market data, and other financial information. An AI system, such as a predictive analytics model, analyzes this data to identify trends, risks, and opportunities. The AI system then generates a financial report, summarizing account balances and transactions, analyzing spending patterns, and providing investment performance and recommendations. A financial analyst reviews this AI-generated report, validates the analysis, and adds personalized advice for the customer. The final report, merging AI-generated content with the analyst's input, is then shared with the customer.

In medical, financial, tax, sports, and many other areas, AI systems enhance efficiency and accuracy. However, in the field of automated content generation, the problem arises of distinguishing between non-AI content that is based on human authorship, measured data, result data, manually entered data, etc., and content that is generated using AI. Visually indicating AI-generated content and/or non-AI-generated content facilitates distinguishing AI-generated content from non-AI-generated content by presenting an identification of content type with minimal cost and/or invasiveness.

In embodiments, a report, message, summary, or other document is generated by an engine using AI. The engine presents a resulting content item from a generative model with a visual indicator indicating that the content item was generated by AI. The resulting content item is presented along with related data that is not generated by AI. The resulting content item is distinguished by the visual indicator.

Content items for which it is not known if the content item was generated by AI are evaluated by a model that has been trained to infer a likelihood that a content item was generated by AI. In some embodiments, attributes of the visual indicator are used to indicate a confidence value based on the likelihood inferred by the model. The confidence value represents a confidence that the indicated content has been generated by AI.

A confidence value is also used that represents a confidence that the content of an AI-generated content item is accurate in some embodiments. One or more different confidence values are used and indicated by one or more aspects of the visual indicator. For example, one or more of a thickness, brightness, color, style, shape, type, etc., of the visual indicator is changed and/or scaled to indicate the confidence value.

In various embodiments, visual indicators are used to indicate AI-generated content, such as summaries, draft work items, draft messages, etc. Additionally, or alternatively, visual indicators are used to indicate content that is non-AI generated content.

### 3. CONTENT TYPE IDENTIFICATION SYSTEM

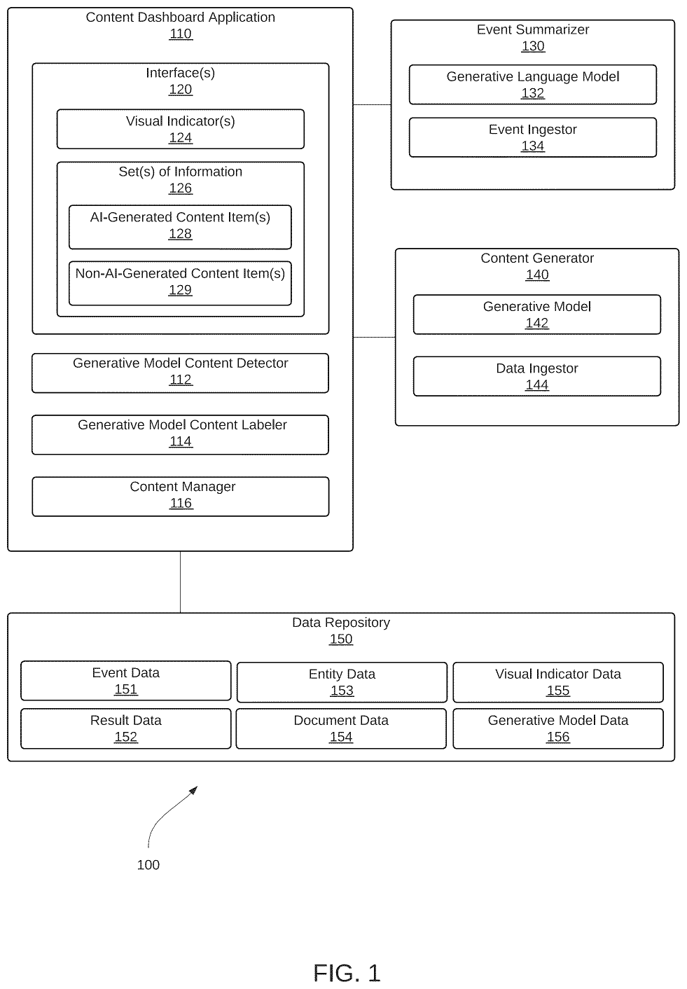

One or more embodiments include a content type identification system such as system 100 illustrated in FIG. 1. System 100 visually identifies one or both of AI-generated content and non-AI-generated content to enable a viewer to distinguish one from the other in a hybrid graphical user interface that includes both AI-generated content and non-AI-generated content.

In one example implementation of the system 100, the system 100 includes a content dashboard application 110, an event summarizer 130, a content generator 140, and a data repository 150. The content dashboard application 110 includes a generative model content detector 112, a generative model content labeler 114, a content manager 116, and one or more interfaces 120. The content dashboard application is connected (i.e., via networked communication or other electronic connection) to an event summarizer 130, a content generator 140, and a data repository 150.

In FIG. 1, the generative model content detector 112 is a trained machine learning model that has been trained to infer a likelihood that input content was generated using AI. In some embodiments, the generative model content detector 112 receives a content item and determines if the content item was generated using AI. Generative model content detector 112 identifies content generated by AI models by analyzing textual patterns, stylistic nuances, and contextual coherence to distinguish between human-written and machine-generated content. Machine learning algorithms are applied to assess the likelihood that a given piece of text was produced by a generative model.

The generative model content labeler 114 performs operations associated with presenting a visual indicator in association with an AI-generated content item. For example, the generative model content labeler 114 determines a type, appearance, and/or position of the visual indicator to be displayed in association with AI-generated content. The generative model content labeler 114 labels the AI-generated content item response to the AI-generated content item being indicated as AI-generated and/or in response to a likelihood determined by the generative model detector 112.

In embodiments, the generative model content labeler 114 applies logic to determine an appearance of a visual indicator. A first attribute of the visual indicator, such as a color or thickness, is based on a confidence of the accuracy of the content, and one or more other attributes of the visual indicator are based on a confidence or likelihood that the content was generated using generative AI, a type of content, and/or another criterion.

The content manager 116 includes logic and modules for arranging and presenting content items. For example, a plurality of content items is presented in a GUI. The content manager 116 determines the order, placement, size, grouping, and/or other attributes of the content items presented in the GUI. The content manager 116 receives input from a user to result in navigating, expanding, closing, moving, and/or performing other actions related to content items or content item management.

In various embodiments, various interface(s) 120 include visual indicators 124 and/or one or more set(s) of information 126. Generally, an interface 120 refers to hardware and/or software elements configured to facilitate communication between a user and a system such as by displaying information using a screen or monitor. In examples herein, the one or more interfaces 120 refer to GUIs that are displayed in a user dashboard. Elements of the dashboard, such as AI-generated summaries, AI-generated draft messages, or other AI-generated content, are presented with respective visual indicators 124.

The visual indicators 124 refer to graphical user interface (GUI) elements that are presented near to or alongside AI-generated content to indicate that the AI-generated content has been generated using AI. In various embodiments, the visual indicator is a GUI element, such as a band or ribbon alongside an AI-generated textual content item. In other embodiments, the visual indicator is a highlighting, underlining, or other formatting of the text. In embodiments, a color, bolding, scale, or thickness of the visual indicator corresponds to a confidence value for the indicator.

The set(s) of information 126 include various content items, such as documents, summaries, labels, messages, and other content items. In the example, the one or more set(s) of information include one or more AI-generated content items 128 and/or non-AI-generated content items 129.

The generative model detector 112 determines if the AI-generated content items 128 are generated using a generative model. The AI-generated content items 128 are displayed in a GUI with a visual indicator 124 shown for the AI-generated content items 128 to inform a viewer that the content items were AI-generated. In some embodiments, AI-generated content items 128 are received with a label or other indication that the content item was AI-generated without requiring detection using the detector 112. In embodiments, various detectors 112 are deployed to determine if various generative AI models were used to generate a content item.

The one or more non-AI-generated content items 129 refers to content items, such as empirical or measured data, manually entered data, manually written messages, and/or other content, that is not indicated as AI-generated and/or that is determined not to be generated using AI based on result of the generative model content detector 112.

The event summarizer 130 includes modules for ingesting data related to one or more events and for generating natural language summaries of the ingested events. The event summarizer 130 includes a generative language model 132 and an event ingestor 134. In some embodiments, the event summarizer 130 is a model trained for summarizing medical events, such as doctor visits, hospital visits, test results, and/or other medical records associated with a medical intervention or other medical event.

The generative language model 132 receives event data as input and outputs summaries of one or more of the events. The generative language model 132 processes structured or unstructured data about specific occurrences and then produces natural language summaries. Different suitable models deploy various natural language processing techniques and/or neural networks (e.g., conformer models, transformer models, etc.) to understand and interpret the input data.

The generative language model 132 receives ingested event data from the event ingestor 134. Various event data of different formats includes text descriptions, timestamps, participant information, results, measurements, and other relevant details. After processing the data, the model generates a summary by selecting and condensing the information. The output is a coherent and readable summary that captures significant actions, outcomes, and implications of the event. In an example, an output of the generative language model 132 is used as a basis for the AI-generated content item 128. Based on the output of the generative language model 132 indicating that the output is AI-generated, the AI-generated content item 128 is presented in an interface 120 with a visual indicator 124.

The event ingestor 134 includes modules, templates, logic, and/or other instructions for converting event records into a data format suitable for data input into a generative language model. For example, the event ingestor 134 receives a signal from an event recording device and converts the received signal to event data. The generative language model 132 generates AI summaries of events ingested by the event ingestor 134.

The content generator 140 includes modules, templates, logic, and/or other instructions for generating content using ingested data. For example, a natural language summary is generated by a generated pretrained transformer (GPT) model for a set of ingested documents. The content generator 140 includes a generative model 142 and a data ingestor 144.

The generative model 142 includes generative models for generating text, image, video, sound, or the like. In an example, the data ingestor 144 includes modules and/or hardware (such as a scanner) for parsing document content into elements based on type. In some embodiments, a plurality of generative models 142 are used to generate text, image, video, or sound corresponding to types of elements in parsed documents. In embodiments, the generative model 142 drafts natural language content used for a draft work item (such as a text document or draft email) that is presented with a visual indicator in a word processing interface.

Generally, the data repository 150 stores data loaded onto the data repository 150 from the content dashboard application 110, the event summarizer 130, the document content generator 140, and/or another source. In various embodiments, the data repository stores one or more types of data including, but not limited to, event data 151, result data 152, entity data 153, document data 154, visual indicator data 155, and/or generative model data 156.

Event data 151 refers to information that records occurrences or activities within a system or environment. This type of data captures specific events, such as user actions, system updates, or environmental changes, and often includes timestamps, descriptions, and relevant metadata. Event data also includes information input into the system about certain events, such as a doctor visit, hospital visit, sporting contest result, financial transaction, or the like.

Result data 152 encompasses information generated from various sources, such as quality assurance tests, medical tests, or academic assessments. This data includes the outcomes of tests, scores, metrics, and any relevant observations or anomalies. Result data is used for evaluating performance, diagnosing issues, or performing other actions based on empirical evidence in various fields, like healthcare, education, software development, and manufacturing.

Entity data 153 represents information about distinct objects or entities within the system 100, including people, organizations, products, or any identifiable items. This data typically consists of attributes or properties, such as names, identifiers, characteristics, and relationships with other entities. Entity data is fundamental for building databases, creating relationships between different data points, and supporting various applications.

Document data 154 refers to information contained within structured or unstructured documents, such as text files, spreadsheets, and forms. This data includes the content, format, metadata, and any embedded media or annotations within the documents.

Visual indicator data 155 encompasses data used to generate visual indicators. This includes graphical elements, templates, or other data related to creating types of comprehensible visual identifications of AI-generated content and/or attributes related to confidence values for the AI-generated content.

Generative model data 156 involves information produced or required by generative models. Generally, generative models are types of AIAI systems designed to generate new data instances describing an input data set. This data includes training data and images, texts, sounds, or other data created based on learned patterns from training data.

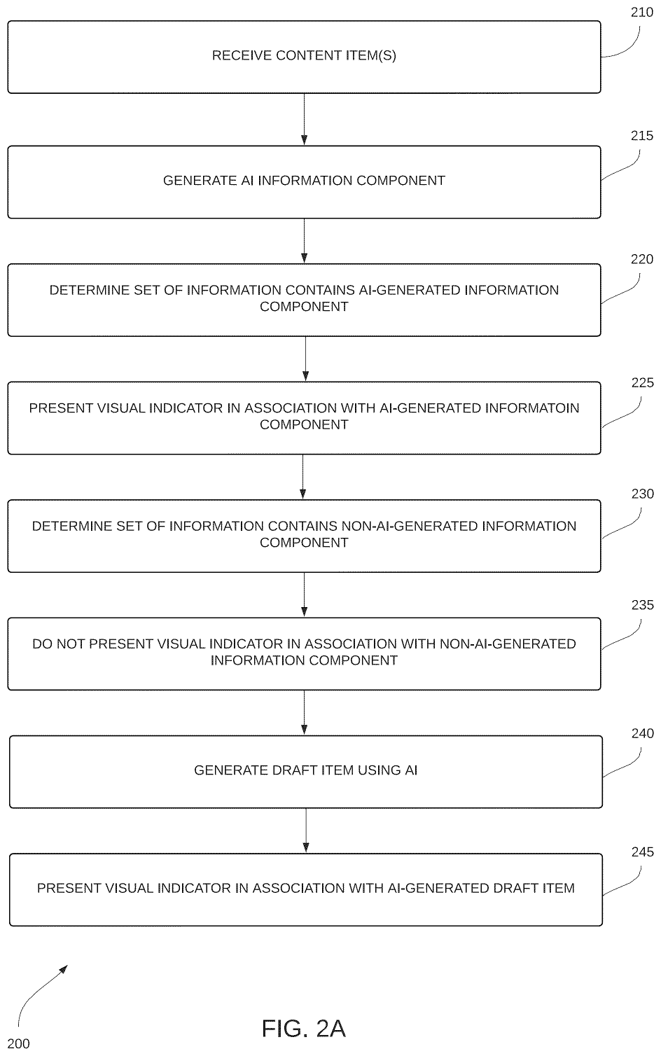

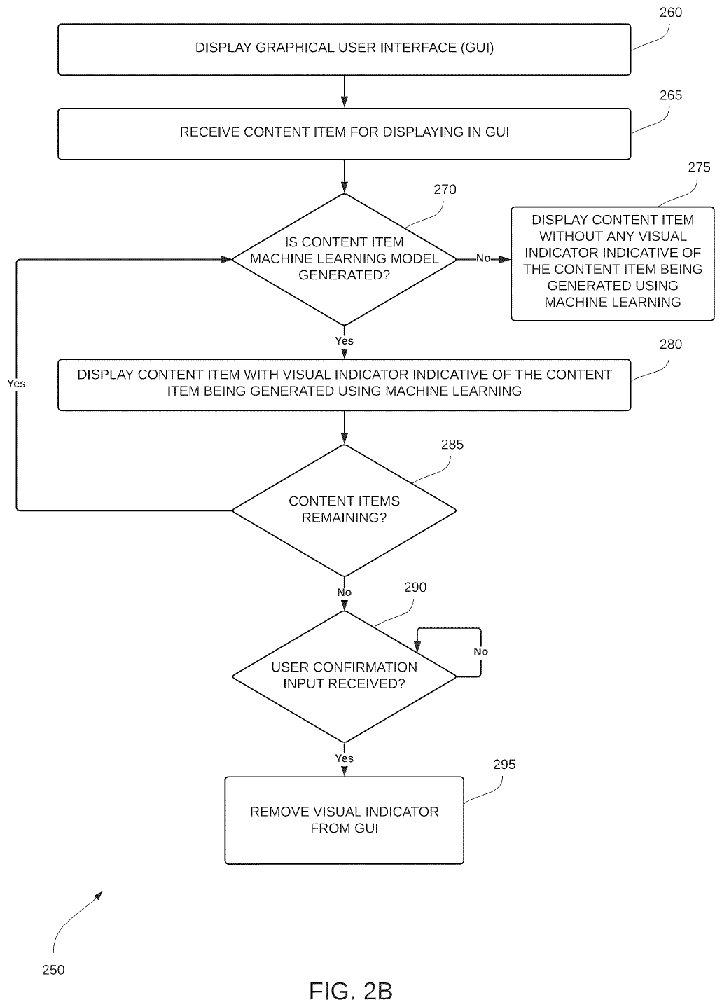

Examples of operations for using visual indicators performed by the system 100 are described below with reference to FIG. 2.

As shown, the visual indicator system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface refers to hardware and/or software configured to facilitate communication between a user and a system. In FIG. 1, an interface 120 is used to facilitate communication between the content dashboard application 110 and/or one or more computing devices. Such an interface renders user interface elements and receives input via user interface elements. Examples of interfaces include a GUI, a command line interface, a haptic interface, and a voice command interface. Examples of user interface elements include checkboxes, radio buttons, dropdown lists, list boxes, buttons, toggles, text fields, date and time selectors, command lines, sliders, pages, and forms.

In various embodiments, different components of such an interface are specified in different languages. The behavior of user interface elements is specified in a dynamic programming language such as JavaScript. The content of user interface elements is specified in a markup language, such as hypertext markup language, extensible markup language, user interface language, or another markup language. The layout of user interface elements is specified in a style sheet language such as cascading style sheets. In embodiments, interfaces are specified in one or more other languages, such as Java, C, C++, or another programming language.

### 4. VISUALLY DISTINGUISHING AI-GENERATED CONTENT FROM NON-AI-GENERATED CONTENT

FIG. 2A illustrates an example set of operations 200 for a visual indicator system in accordance with one or more embodiments. One or more operations illustrated in FIG. 2A may be modified, rearranged, or omitted. Accordingly, the particular sequence of operations illustrated in FIG. 2A should not be construed as limiting the scope of one or more embodiments.

The system receives one or more content items (Operation 210). For example, the one or more content items are stored in a data repository and/or received from an event summarizer, a content generator, and/or other sources. The one or more content items include content items that are generated by AI and content items that are not generated by AI. In an embodiment, a content item is known to be generated using AI based on the content item being received from a generative model or from a source known to use AI to produce output, whereas other content is not generated by AI. Content that is not generated by AI includes measured content or human-drafted content, for example. Content items are received by an application that organizes and/or displays the content in a content item dashboard.

The system generates an AI information component (Operation 215). The AI information component refers to one or more content items that were generated by AI. Various machine learning models are used in different embodiments to generate different types of content. Various large language models, such as a generative pretrained transformer model, are suitable for producing natural language summaries of ingested events, occurrences, test results, records, and/or other data. For example, generative models can also be trained and used to produce images or other content items based on a prompt consisting of input text and/or other ingested data.

The system determines a set of information contains an AI-generated information component (Operation 220). In some embodiments, the AI-generated information component is received by the system with an indication that the component is AI-generated. In this case, the AI-generated information component is identified by the indication received with the content. In embodiments, an AI-generated information component is received from a large language model or other source known to use AI. The system determines that the set of information contains an AI-generated information component based on the information component being received from the large language model or other source known to use AI.

In some embodiments, the AI-generated information is received without an indication of if the AI-generated information is AI-generated. In some cases, a generative model content detector is used to determine a likelihood and/or confidence that information was generated by AI. Various detector models produce confidence values for different types of content indicating a confidence that a particular content item was produced by AI (or was likely produced by AI).

For example, an attribution model analyzes writing style and/or linguistic patterns to determine the likelihood that a given text was written by AI or by a human. Attribution models use various features, such as lexical, syntactic, semantic, and pragmatic characteristics of the text to define parameters that the models use to determine the likelihood that the text was written either by AI or by a human. Various attribution models deploy machine learning techniques, including supervised learning, neural networks, deep learning frameworks, and other techniques used in feature extraction and analysis to determine a level of confidence or confidence value indicating a likelihood that an input was generated by AI.

The system presents a visual indicator in association with the AI-generated information component (Operation 225). In embodiments, the visual indicator is presented with the AI-generated information in such a way as to emphasize or distinguish the AI-generated content item. In an example, a rainbow-colored banner or bar is included in a GUI element of a content item dashboard alongside the information that was generated by AI. In other examples, the visual indicator comprises one or more of a coloration, background, highlighting, underlining, bolding, font, scale, shape, another emphasis type, or a combination of emphasis types.

In various embodiments, different AI-generated information components are included in a set of content items received by the system. The AI-generated information components of different embodiments include text, images, summaries, inferences, extrapolations, graphs, charts, and/or other visual content that has been generated using a generative model. Natural Language Processing (NLP) models, for example, produce coherent and contextually relevant text ranging from short sentences to comprehensive articles. NLP models leverage extensive datasets and sophisticated algorithms to understand and emulate human-like language patterns effectively.

AI-generated text encompasses a wide spectrum, including news articles, product reviews, creative writing, technical documentation, and conversational dialogue for virtual assistants and chatbots. Example AI models employed for text generation include GPT (Generative Pre-trained Transformer) models, BERT (Bidirectional Encoder Representations from Transformers) models, recurrent neural network (RNN) based models, such as LSTM (Long Short-Term Memory), Seq2Seq models, and other different content generation models. AI-generated content received from such models is presented with a visual indicator. An attribute of the visual indicator, such as color, indicates what model generated the content.

In addition to text, different generative models are suitable for generating AI-generated content of different types. Generative Adversarial Networks (GANs) are neural network architectures that generate images from input data. Variational autoencoders learn a probabilistic distribution of input data and generate new images by sampling from this distribution, allowing for diverse and novel outputs. Models like GPT can generate text and/or images from textual descriptions. Transformers models have also been adapted for generating visual content using Deep Convolutional Generative Adversarial Networks (DCGANs). Using these models and/or other techniques, representations of data related to a patient's condition are generated. In a particular example, based on data such as available test results or other metrics for a patient, a graph, chart, heat map, or other graphic element is generated using AI. The AI-generated graphic element is presented with a visual indicator.

The visual indicator is presented with the content item including the AI-generated information based on a size, shape, type, or other property of the content item. For example, a visual indicator is formatted by the system based on the size of content item and/or the AI-generated information portion of the content item. For example, one or more lines of text of a textual graphical user interface element are presented with a visual indicator to indicate that the text was generated using AI. In another example, the entire graphical user interface element including the AI-generated information is presented with a visual indicator. In some cases, a plurality of content items is displayed in a content item dashboard. In such cases, the system formats the plurality of content items and the visual indicators for the plurality of content items.

In an example content item dashboard, different areas of the dashboard correspond to different types of content. Areas of the dashboard correspond to one or more content types such that only the corresponding content types are present in a particular area of the dashboard. Different content types include AI-generated content, non-AI-generated content, human-authored content, AI-generated content that has been validated or confirmed by a user, AI-generated content that has been edited by a user, imported data content, unknown-type content, and/or other content types. Based on the content types, content items are presented in different areas of the dashboard and/or with different visual indicators.

In one example, a dashboard area includes a plurality of content types having visual indicators. For example, an area of the dashboard includes an interface for sending a message. A portion of the message that has been generated using AI is presented with a first visual indicator. A portion of the message that has been generated using AI and that has been edited (or validated) by a user is presented with a second visual indicator. A portion of the message that is human authored is presented with a third visual indicator. The first, second, and third visual indicators have different attributes to indicate the different content types.

In an example, the entire message is included in a designated area of a content item dashboard. Yet another area of the dashboard includes only AI-generated content. Yet another area of the dashboard includes no AI-generated content. Areas of the dashboard have a plurality of different visual indicators for different content types within the respective areas.

In embodiments, content items are loaded into a dashboard at a runtime for an application of the system. As content items are loaded, the system performs a runtime analysis for the content items. The runtime analysis may include applying a function or a machine learning model to a set of content for estimating whether the set of content is AI-generated or non-AI-generated. The function or machine learning model determines whether the set of content is AI-generated or non-AI-generated, based on the presence of a label and/or metadata associated with the content item, and/or based on an attribution model result or other analysis.

The system determines a set of information contains a non-AI-generated information component (Operation 230). In embodiments, the system determines that the information was not received with an indication that the information was generated using AI. In some cases, the non-AI-generated content is known to be non-AI-generated based on being received from a source that is known to not include AI. For example, recorded data is received from a recording device, or test results are input into a computer by a human. In another example, an attribution model determines that the non-AI-generated content was written by a human (or was not likely produced by AI).

The system does not present a visual indicator in association with the non-AI-generated component (Operation 235). Responsive to determining that the information was not received with an indication that the information was generated using AI, the system presents the non-AI-generated component without the visual indicator. For example, the non-AI-generated component is presented in a content item dashboard without a rainbow-colored banner or bar, and/or without a color, background, highlighting, underlining, bolding, scale, shape, etc., or a combination of the same used to indicate AI-generated content.

In the example, the visual indicator is used to indicate that a content item was generated by AI. However, in some embodiments, a visual indicator is presented with non-AI-generated information, and no visual indicator is presented with AI-generated information. In such embodiments, content items are presented with visual indicators if it is determined that the content items were not generated by AI (for example, if it is determined that the content item is empirical data or is human generated) and, likewise, content items that were generated by AI are presented without visual indicators. Furthermore, in some embodiments, one or more visual indicators are used to indicate AI-generated information, and one or more different visual indicators are used to indicate non-AI-generated information.

The system generates a draft item using AI (Operation 240). In embodiments, one or more draft content items are generated using a generative machine learning model, such as a transformer, conformer, and/or diffusion model. In some cases, the AI-generated information is used to create a document or text, such as a draft summary or message to a subject, client or patient, or a draft referral. In an embodiment, a draft work item includes an AI-generated summary about a patient and condition. A generated draft content item is presented to a user in an editor or confirmation interface of the content item dashboard. The user edits and/or confirms the draft content item using the dashboard.

The system presents a visual indicator in association with the AI-generated draft item (Operation 245). In embodiments, the draft item generated at operation 240 is presented to the user in the editor or confirmation interface with the visual indicator for the draft item. In a particular example, the draft item is a natural language draft message, such as an email or letter from a doctor to a patient, that includes various elements, such as a summary, description, request for an appointment, and/or other generated text related to a patient condition.

FIG. 2B illustrates an example set of operations 250 for a visual indicator system in accordance with one or more embodiments. One or more operations illustrated in FIG. 2B may be modified, rearranged, or omitted. Accordingly, the particular sequence of operations illustrated in FIG. 2B should not be construed as limiting the scope of one or more embodiments.

In FIG. 2B, the system displays a GUI (Operation 260). In embodiments, the GUI presents various content items and other GUI elements in the GUI. The GUI displays various text, labels, navigation elements, graphical elements, and the like. The GUI also displays one or more information components. In embodiments, the information components include information that has been generated by AI and information that has not been generated by AI.

The system receives a content item for displaying in the GUI (Operation 265). Various types of content items include text, messages, images, graphs, tables, charts, etc. Content items of various types include information components that have been generated by AI by the system, information components that have been received from a data repository, and/or information components that have been received by the system from another source. Other sources include sources that generate information using AI and sources that provide information that was not generated using AI.

The system determines if the content item was generated using a machine learning model (Operation 270). In various embodiments, the system determines the content item was generated by a machine learning model based on a source, indication, or confidence value for the content item. For example, the system provides input to a large language model and determines that the output of the large language model was generated using a machine learning model based on the large language model being a machine learning model. In another example, the system utilizes an attribution model to detect if the content item was generated using AI.

If the content item is not machine learning model-generated, the system displays the content item without any visual indicator indicative of the content item being generated using machine learning (Operation 275). In various embodiments, the content item is displayed in a dashboard of GUI elements in a default format and/or without a visual indicator.

If the content is machine learning model-generated, the system displays the content item with a visual indicator indicative of the content item being generated using machine learning (Operation 280). In various examples, the visual indicator is a colored bar, underlining, or other feature of emphasis provided in accordance with (next to, behind, under, etc.) the machine leaning model-generated content item (or a portion of the content item generated using machine learning). A particular example uses a multi-colored banner, ribbon, or bar placed adjacent to or near machine learning model-generated text. A coloration, thickness, shape, and/or “heat” (a.k.a. a select color gradient) of the banner, ribbon, or bar indicates a feature of the text, such as a confidence that the text is accurate or a confidence that the text was generated using machine learning.

The system determines if there are more content items (Operation 285). As the system loads the GUI, the system determines if a set of content items to be displayed in the queue has any remaining content items. The system selects a content item from the remaining content items if there are content items remaining to be loaded into the GUI.

If there are content items remaining, the system determines if a content item was generated using a machine learning model (Operation 270). The operations continue at Operation 270 if there are content items remaining. The system determines if content items were generated using a machine learning model for remaining content items of the content items to be displayed in the GUI.

If there are no content items remaining, the system determines if user confirmation has been received for AI-generated content (Operation 290). User confirmation includes, for example, a user action providing verification that the AI-generated content is accurate. If user confirmation has not been received, the system continues to display visual indicators identifying AI-generated content. In embodiments, a checkbox or other confirmation element is displayed in accordance with the visual indicator until a user interacts with the confirmation element. When a user interacts with the checkbox or other confirmation element, the visual indicator and the confirmation element are both removed.

If the system determines user confirmation has been received, the system removes the visual indicator from the GUI (Operation 295). In embodiments, the machine learning model-generated content is displayed to a user in an editor interface. The user can edit and then confirm the content. Once the user has confirmed the content, the visual indicator is removed. In embodiments, the machine learning model-generated content is displayed to the user without a user editing interface, and the system removes the visual indicator from the GUI based on the user confirmation validating the machine learning model-generated content. In embodiments where a checkbox or other confirmation element is displayed in accordance with the visual indicator until a user interacts with the confirmation element, user interaction with the checkbox or other confirmation element results in the visual indicator and the confirmation element both being removed from the GUI by the system.

FIGS. 2A and 2B describe an embodiment in which AI-generated content is visually annotated. In other alternative embodiments, non-AI-generated content is annotated with visual indicators. Alternatively, both AI-generated and non-AI-generated content are visually annotated with respective types of visual indicators that help a viewer distinguish the AI-generated content from the non-AI-generated content. Furthermore, the system visually distinguishes AI-generated content, non-AI-generated content, user-verified AI-generated content, and/or other types of content using a plurality of types of visual indicators.

In yet another embodiment, machine learning model-generated content is displayed to a user in a first portion of the GUI. Responsive to the user confirmation for the content, the content is displayed in a second portion of the GUI and/or removed from the first portion of the GUI. In embodiments, a first portion of the GUI corresponds to machine learning model-generated content, and model-generated content is displayed in the first portion of the GUI. In embodiments, a second portion of the GUI corresponds to non-machine learning model-generated content, and non-machine learning model-generated content is displayed in the second portion of the GUI. Responsive to user confirmation indicating confirmation (e.g., human validation) for a particular content item in the first portion of the GUI, the particular content element is transferred to the second portion of the GUI to indicate that the content has been confirmed or validated by a human.

### 5. EXAMPLE EMBODIMENTS

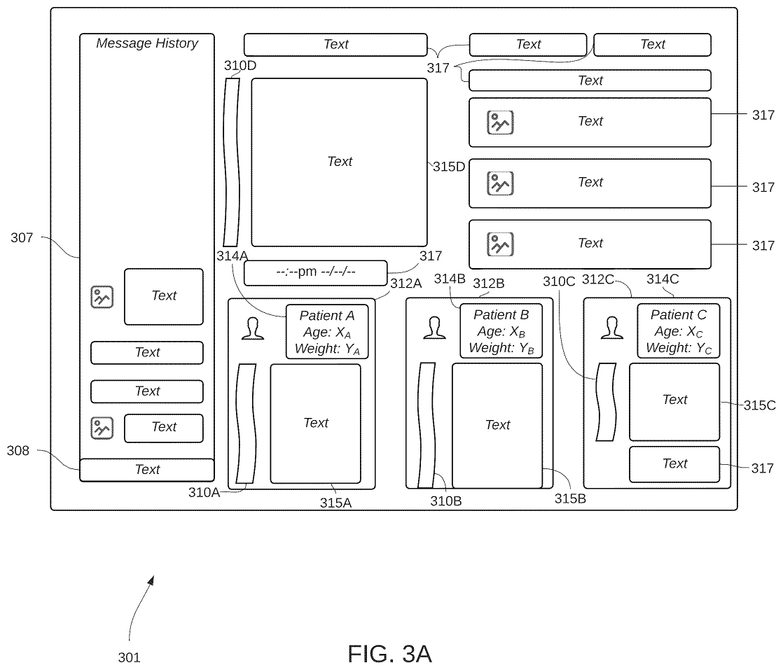

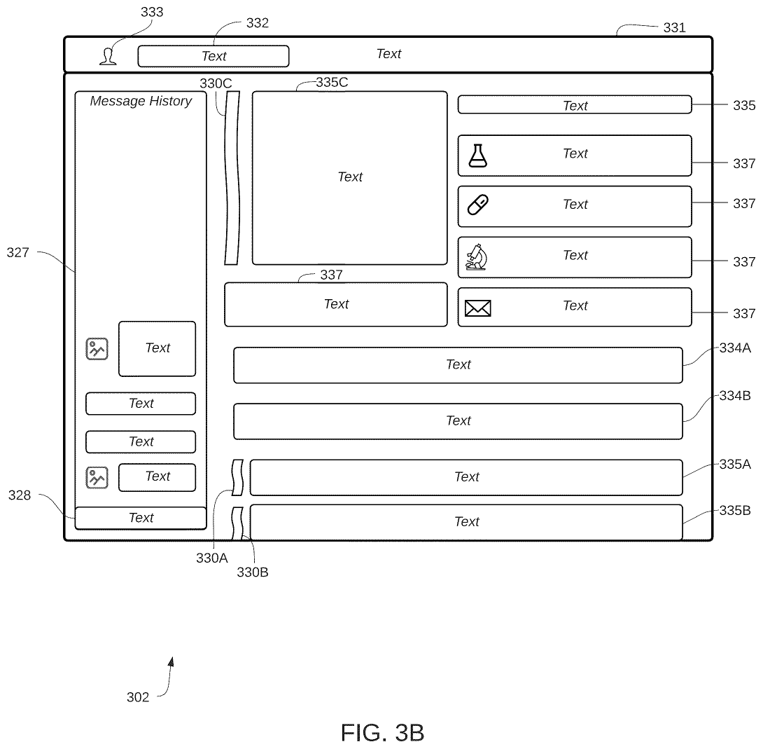

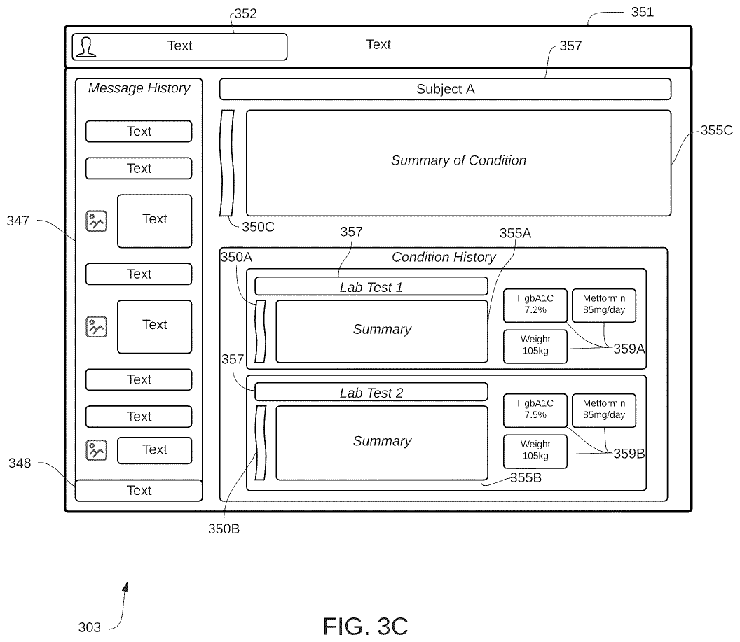

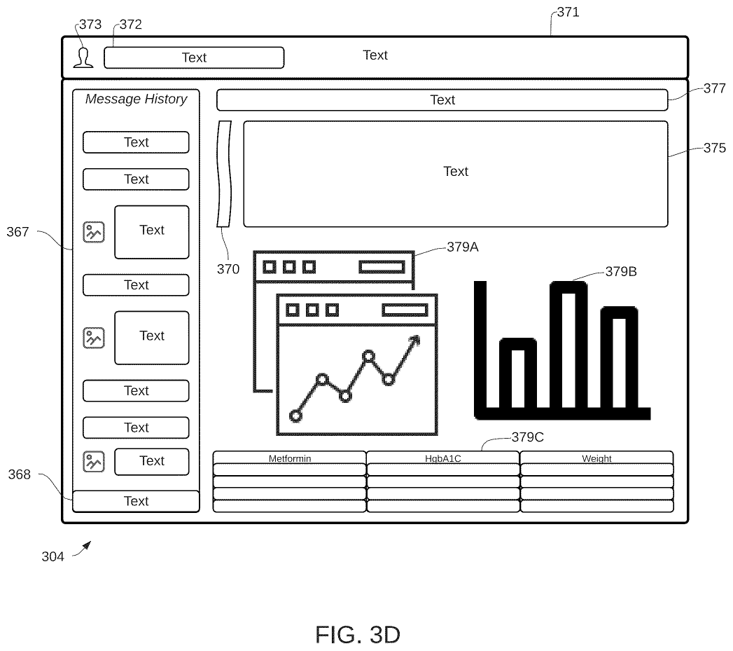

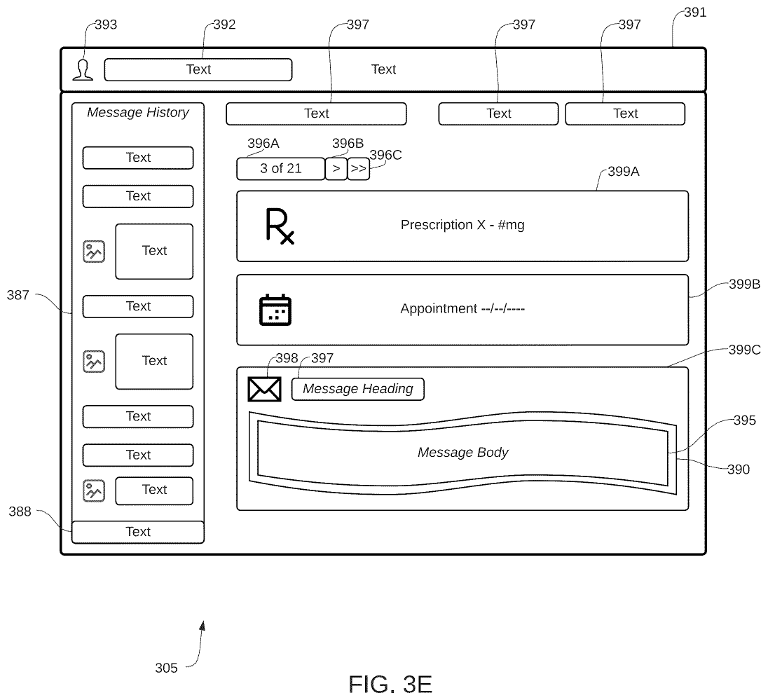

FIGS. 3A-E illustrate example GUIs for a heterogeneous content management engine in accordance with one or more embodiments.

FIG. 3A illustrates a first GUI 301. In FIG. 3A, the first GUI 301 is a first dashboard view for a medical practitioner dashboard. In the example, the first GUI 301 is a daily summary view that displays attention items, patient cards, scheduling information, an AI-generated daily summary, and/or one or more AI-generated patient summaries.

The first GUI 301 includes a chatbot history 307, a chatbot input field 308, and various dashboard elements 317. In the example shown, the chatbot history 307 displays a history of responses to input received by the chatbot via the chatbot input field 308. In the various embodiments, the dashboard elements 317 include information labels for names, actions, subjects, patients, dates, time, page numbers, attention items, and/or other textual elements. The dashboard elements 317 of some embodiments include interactive elements that are movable, expandable, and/or closable include links to other GUIs, and/or include icons representing a type or purpose of the dashboard element 317. The dashboard elements 317 facilitate organization, management, and presentation of daily attention items, scheduling information, dashboard navigation, and the like.

In FIG. 3A, the first GUI 301 includes visual indicators 310A, 310B, 310C, and 310D that are used to show that AI-generated content items 315A, 315B, 315C, and 315D were generated using AI. In the example, the AI-generated content items 315A-C include a summary of one or more conditions, test records, and/or event records for a medical patient, and the AI-generated content item 315D includes an AI-generated summary. In the example, the AI-generated content item 315D includes a summary of appointments, events, other occurrences for the day, and/or other items.

In the example, a first patient card interface 312A includes an AI-generated content item 315A and a visual indicator 310A. A patient card interface in general includes a patient information display and a patient icon in a GUI element managed by the dashboard application. Likewise, a second patient card interface 312B includes a second AI-generated content item 315B and a second visual indicator 310B, and a third patient card interface 312C includes a third AI-generated content item 315C and a third visual indicator 310C.

The AI-generated content items 315A-C include summaries for the patients associated with the patient card interfaces 312A-C. For example, the AI-generated content items are patient-specific summaries of conditions, histories, and/or attributes of patients that are the subjects of the patient cards. Patient information boxes 314A, 314B, and 314C present various patient information, such as name, age, weight, etc. In the example, the patient cards provide various empirical information about the patient that is not presented with a visual indicator. The illustrated patient cards present patient-specific AI-generated summaries that are presented with a visual indicator.

FIG. 3B illustrates a second GUI 302. In FIG. 3B, the second GUI 302 is a second dashboard view for a medical practitioner dashboard. In the example, the second GUI 302 is a patient summary view that displays an AI-generated summary of information associated with a patient (such as attributes, conditions, results, history) and summaries associated with specific conditions for a patient (prognosis trajectory, condition-specific results, condition-specific history, etc.) as well as attention items, medication information, scheduling information, test results, and/or other information associated with a patient.

The second GUI 302 also includes a header 331 having a patient label 332 and a patient icon 333 as well as a chatbot history 327, a chatbot input field 3282, and various dashboard elements 337. The header 331 provides the name of the patient via the patient label 332 that displays text including a patient name and/or other information. The patient icon 333, for example, is a generic patient icon or an image of the patient.

In FIG. 3B, the second GUI 302 includes visual indicators 330A, 330B, and 330C that are used to show that AI-generated content items 335A, 335B, and 335C were generated using AI. In the example, the AI-generated content items 335A and 335B include summaries associated with distinct conditions for the medical patient named in label 332, and the AI-generated content item 335C includes an AI-generated summary that is an overall summary of information associated with the patient (such as attributes, conditions, results, history). In the example, the patient information boxes 334A and 334B provide various empirical information, such as active prescriptions or medications for the patient, that is not presented with a visual indicator. The AI-generated content items 335A, 335B, and 335C are presented with visual indicators 330A, 330B, and 330C to indicate that these pieces of information were generated using AI.

FIG. 3C illustrates a third GUI 303. In FIG. 3C, the third GUI 303 is a third dashboard view for a medical practitioner dashboard. In the example, the third GUI 303 is a patient-specific condition summary view that displays an AI-generated summary of information associated with a patient's condition and summaries associated with specific events or test results related to the condition as well as attention items, medication information, scheduling information, a test results, and/or other information associated with the patient or condition.

The third GUI 303 also includes a header 351 having a patient condition label 352 that provides text depicting the name of the patient and condition for the view as well as a chatbot history 347, a chatbot input field 348, and various dashboard elements 357.

In FIG. 3C, the third GUI 303 includes visual indicators 350A, 350B, and 350C that are used to show that AI-generated content items 355A, 355B, and 355C were generated using AI. In the example, the AI-generated content items 355A and 355B include summaries associated with distinct events for the medical condition and patient named in label 352, and the AI-generated content item 355C includes an AI-generated summary that is an overall summary of information associated with the condition (such as prognosis trajectory, events, results). In the example, the event information boxes 359A and 359B provide various empirical information, such as height, weight, age, active prescriptions or medications for the patient, test results, and/or the like, that is not presented with a visual indicator. The AI-generated content items 355A, 355B, and 355C are presented with visual indicators 350A, 350B, and 350C to indicate that the pieces of information included in the AI-generated content items 355A, 355B, and 355C were generated using AI.

FIG. 3D illustrates a fourth GUI 304. In FIG. 3D, the fourth GUI 304 is a fourth dashboard view for a medical practitioner dashboard. In the example, the fourth GUI 304 is a test result history view that displays an AI-generated summary of information associated with a history of test results associated with a particular condition for a patient as well as attention items, medication information, scheduling information, test results, and/or other information associated with the patient, condition, or related tests.

The fourth GUI 304 also includes a header 371 having a patient label 372 and patient icon 373 as well as a chatbot history 367, a chatbot input field 368, and various dashboard elements 377.

In FIG. 3D, the fourth GUI 304 includes a visual indicator 370 that is used to show that an AI-generated content item 375 was generated using AI. In the example, the AI-generated content items 375 include a summary associated with a test result history for a medical condition for the patient named in label 372. In the example, test result information elements 379A, 379B, and 379C provide a history of test results or other various empirical information in the form of a line graph, bar graph, table, chart, or the like. The content item 375 provides a natural language summary of the test results depicted in the information elements 379A, 379B, and 379C. The information elements 379A, 379B, and 379C are presented without visual indicators. The natural language summary of test results included in the AI-generated content item 375 is presented with visual indicator 370 to indicate that this piece of information was generated using AI.

FIG. 3E illustrates a fifth GUI 305. In FIG. 3E, the fifth GUI 305 is a fifth dashboard view for a medical practitioner dashboard. In the example, the fifth GUI 305 displays a patient work item view showing one or more draft work items. The one or more draft work items include a draft work item with an AI-generated portion.

The fifth GUI 305 also includes a header 391 having a patient label 392 and patient icon 393 as well as a chatbot history 3878, a chatbot input field 3888, and various dashboard elements 397. In the example, the fifth GUI 305 includes navigation elements 396A, 396B, and 396C. The navigation element 396A displays a work item count and a total work item count. Navigation elements 396B and 396C facilitate managing the work items that are displayed by the fifth GUI 305.

The fifth GUI 305 includes a visual indicator 390 that is used to show that an AI-generated content item 395 has been generated using AI. In the example, the AI-generated content item 395 is a draft work item. The AI-generated draft work item includes text that was generated by AI. For example, the draft work item contains text, such as a summary of a doctor visit, test result, condition, a request for an appointment, and/or other AI-generated content. In an example embodiment, the draft work item includes a medical history summary for a medical condition affecting the patient named in label 392. Various work items include requests for appointments, orders for tests, referrals, prescriptions, other documents drafted by a medical practitioner, and the like.

In the example, a first item 399A is a draft prescription order that has been generated using a template. A second item 399B is an appointment request that has been generated automatically in response to a triggering condition. A third item 399C is an AI-generated message to a patient summarizing a result related to a condition and/or requesting an appointment related to the condition. The third item 399C has been generated using a large language model to produce a natural language message to a patient. The items 399A and 399B are presented without visual indicators. The AI-generated draft work item 399C is presented with the visual indicator 390 to indicate that the indicated content was generated using AI. In the example, the visual indicator is a box or banner that surrounds the AI-generated content. The visual indicator is provided with a color, boldness, or other emphasis. One example is a rainbow-colored rectangle surrounding AI-generated text of the AI-generated draft work item 399C.

In various embodiments, visual indicators are presented with various other types of AI-generated content, and/or visual indicators are presented that have various distinct visual appearances.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a content type identification system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a content type identification system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a content type identification system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

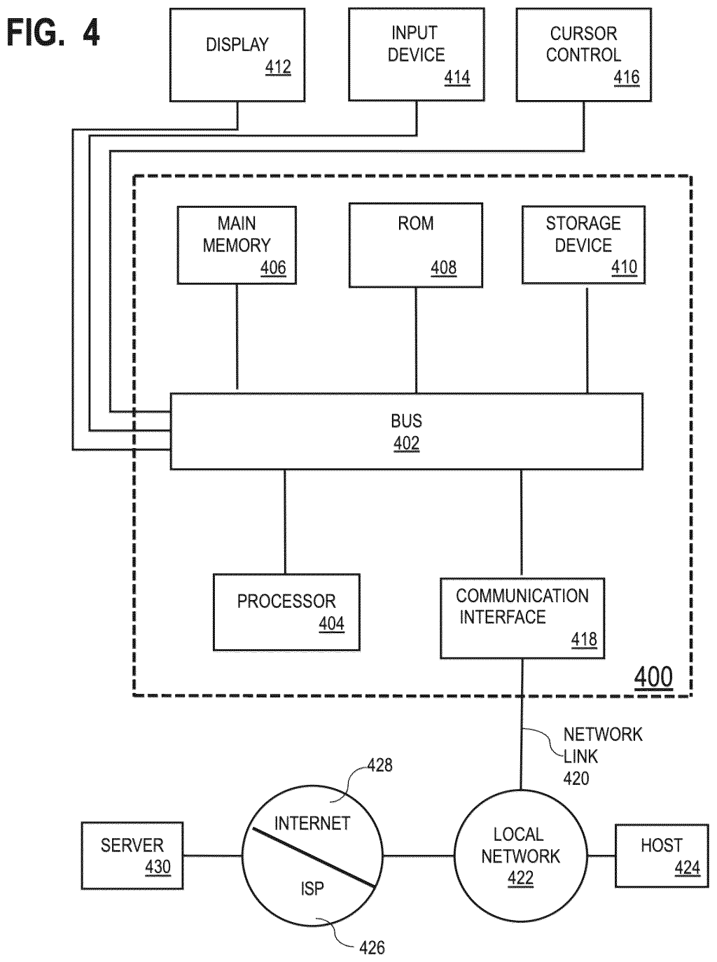

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
displaying, in a Graphical User Interface (GUI), a first interface element comprising a first content item;
based on the first content item being generated using a machine learning model: displaying, in the GUI, a second interface element comprising a visual indicator in association with the first content item, wherein the visual indicator is indicative of the first content item being generated using the machine learning model;
displaying, in the GUI, a third interface element comprising a second content item;
based on the second content item not being generated using any machine learning model: refraining from displaying, in the GUI, any visual indicators in association with the second content item that are indicative of the second content item being generated using any machine learning model, wherein
the method is performed by at least one device including a hardware processor.

2. The method of claim 1, comprising:
receiving user input verifying the first content item;
responsive to user input verifying the first content item, removing the second interface element from the GUI.

3. The method of claim 1, comprising:
receiving user input editing the first content item;
responsive to user input editing the first content item, removing the second interface element from the GUI.

4. The method of claim 1, wherein
the visual indicator comprises at least one of:
a colored box surrounding the first interface element;
a colored bar adjacent to the first interface element;
a background color highlighting the first interface element;
an underlining of the first interface element; and
a font coloring of the first interface element.

5. The method of claim 3, wherein
the first content item comprises an AI-generated event summary, and the second content item comprises empirical data.

6. The method of claim 1, wherein
the visual indicator is indicative of a level of confidence associated with the first content item.

7. The method of claim 5, wherein
the visual indicator is indicative of a confidence level that the first content item was generated using the machine learning model.

8. The method of claim 1, wherein
the second interface element comprises an indication of a source of information used by the machine learning model to generate the first content item.

9. The method of claim 1, comprising:
determining whether the first content item is generated by any machine learning model by inputting the first content item to a second machine learning model to cause the machine learning model to output a prediction indicating that the first content item is generated by at least one machine learning model.

10. The method of claim 1, wherein
the machine learning model comprises a generative AI model.

11. The method of claim 1, wherein
the visual indicator is indicative of a type of the machine learning model used to generate the first content item.

12. A graphical user interface (GUI), comprising:
a first interface element comprising a first content item;
a second interface element comprising a visual indicator displayed in association with the first content item; and
a third interface element comprising a second content item, wherein
the second interface element is included in the GUI based on the first content item being generated using a machine learning model;
the visual indicator is indicative of the first content item being generated using the machine learning model; and
the GUI does not include any visual indicators in association with the second content item that are indicative of the second content item being generated using any machine learning model based on the second content item not being generated using any machine learning model.

13. The GUI of claim 12, wherein:
the second interface element is not included in the GUI responsive to user input verifying the first content item.

14. The GUI of claim 12, wherein:
the second interface element is not included in the GUI responsive to user input editing the first content item.

15. The GUI of claim 12, wherein
the visual indicator comprises at least one of:
a colored box surrounding the first interface element;
a colored bar adjacent to the first interface element;
a background color highlighting the first interface element;
an underlining of the first interface element; and
a font coloring of the first interface element.

16. The GUI of claim 12, wherein the first content item comprises an AI-generated event summary, and the second content item comprises empirical data.

17. The GUI of claim 12, wherein
the visual indicator is indicative of a level of confidence associated with the first content item.

18. The GUI of claim 12, wherein
the visual indicator is indicative of a confidence level that the first content item was generated using the machine learning model.

19. The GUI of claim 12, wherein
the second interface element comprises an indication of a source of information used by the machine learning model to generate the first content item.

20. A system, comprising:
at least one device including a hardware processor, the system being configured to perform operations comprising:
displaying, in a GUI, a first interface element comprising a first content item;
based on the first content item being generated using a machine learning model: displaying, in the GUI, a second interface element comprising a visual indicator in association with the first content item, wherein the visual indicator is indicative of the first content item being generated using the machine learning model;
displaying, in the GUI, a third interface element comprising a second content item;
based on the second content item not being generated using any machine learning model: refraining from displaying, in the GUI, any visual indicators in association with the second content item that are indicative of the second content item being generated using any machine learning model.
